(19) United States
(12) Patent Application Publication
(10) Pub. No.: US 2020/0378019 A1
(43) Pub. Date: Dec. 3, 2020

(54) CONTROL SYSTEM AND METHOD OF CHLORINATED BRINE GENERATOR WITH DESCALING DEVICE

(71) Applicant: Dartpoint Tech. Co., Ltd., Taipei City (TW)

(72) Inventor: Chung-Hsin HSIEH, Taipei City (TW)

(21) Appl. No.: 16/703,988

(22) Filed: Dec. 5, 2019

Related U.S. Application Data
(60) Provisional application No. 62/853,195, filed on May 28, 2019.

(51) Int. Cl. C25B 15/02; C25B 1/26; C25B 9/06; C25B 15/08; B08B 7/02

(52) U.S. Cl. CPC C25B 15/02; C25B 1/26; B08B 7/028; C25B 15/08; C25B 9/06

(57) ABSTRACT

A control system of chlorinated brine generator with descaling device includes an electrolysis cell and a controller unit. The electrolysis cell includes a cover, a chlorinated brine generator, and a descaling device. The cover includes an inlet and an outlet, wherein a waterway is defined between the inlet and the outlet. The chlorinated brine generator is arranged in the waterway, and includes a plurality of electrode plates. The descaling device is arranged adjacent to the chlorinated brine generator and in the waterway, and includes an ultrasonic vibrating equipment. The ultrasonic vibrating equipment includes a vibrator. The controller unit includes an electrolysis-and-power controlling module, an ultrasonic generating module, and a main controlling module. The electrolysis-and-power controlling module controls the chlorinated brine generator. The ultrasonic generating module controls the descaling device. The main controlling module controls the electrolysis-and-power controlling module and the ultrasonic generating module, and save a descaling schedule.

### CROSS REFERENCE TO RELATED APPLICATION

This application claims the benefit of filing date of U.S. Provisional Application Ser. No. 62/853,195, entitled “CONTROL SYSTEM AND METHOD OF CHLORINATED BRINE GENERATOR WITH DESCALING DEVICE” filed May 28, 2019 under 35 USC § 119(e)(1).

### BACKGROUND OF THE INVENTION

### 1. Field of the Invention

The present invention relates to control system and method of chlorinated brine generator with descaling device.

### 2. Description of Related Art

Chlorine content and pH level of a swimming pool should be frequently checked and maintained to avoid growth of bacteria and algae in the swimming pool. In order to generate chlorine, an electrolysis cell (also called a chlorinator cell) is introduced into a water circulation system of the swimming pool. However, the electrolysis cell is bound to suffer from mineral deposited or accumulated on its electrodes, which decreases its electrolysis efficiency.

Conventional maintenance of the electrolysis cell involves removing the entire electrolysis cell, disassembling its electrodes, and cleaning the electrodes in an acid bath. The maintenance should be repeated every week or every month. In the worst case, the old electrolysis cell cannot be used anymore and should be replaced by a new one. It can be seen that the conventional maintenance is complicated, time-consuming, and expensive.

Therefore, it is desirable to provide an improved system and method to mitigate and/or obviate the aforementioned problems.

### SUMMARY OF THE INVENTION

Therefore, the present invention aims to provide a system having an electrolysis cell provided with an ultrasonic vibrating equipment (including vibrator(s)) for descaling, and a controller for controlling and optimizing a descaling operation. The descaling operation is performed for a short period (e.g. minutes to hours) between two chlorination (i.e. electrolysis) operations. The ultrasonic vibrating equipment generates ultrasonic waves continuously or intermittently to vibrate water that impacts on electrode plates, thereby removing impurities deposited or accumulated on the electrode plates.

The electrolysis cell may be provided with a vibrating tray, which serves as a (metal) semi-sealed chamber. In this case, the semi-sealed chamber is connected to an ultrasonic vibrating equipment including vibrator(s). Energy of vibrating water by the vibrator(s) will be transmitted to electrode plates of the electrolysis cell, and vibration energy can remove impurities deposited or accumulated on the electrode plates. There is a component designed to be a watertight structure as the periphery of the electrolysis cell.

The electrolysis cell itself may also be a watertight cell. The ultrasonic vibrating equipment is placed in the cell, so as to transmit the energy of vibrating water to the electrode plates directly.

(First Aspect)

According to a first aspect of the present invention, there is provided a control system of chlorinated brine generator with descaling device, including an electrolysis cell and a controller unit. The electrolysis cell includes a cover, a chlorinated brine generator, and a descaling device. The cover includes an inlet and an outlet. A waterway is defined between the inlet and the outlet. The chlorinated brine generator is arranged in the waterway, and includes a plurality of electrode plates. The descaling device is arranged adjacent to the chlorinated brine generator and in the waterway, and includes at least one ultrasonic vibrating equipment. The ultrasonic vibrating equipment includes at least one vibrator. The controller unit includes an electrolysis-and-power controlling module, an ultrasonic generating module, and a main controlling module. The electrolysis-and-power controlling module is connected to the chlorinated brine generator, and configured to control the chlorinated brine generator. The ultrasonic generating module is connected to the descaling device, and configured to control the descaling device. The main controlling module is connected to the electrolysis-and-power controlling module and the ultrasonic generating module, and configured to control the electrolysis-and-power controlling module and the ultrasonic generating module, and save a descaling schedule.

Optionally or preferably, the control system of chlorinated brine generator with descaling device further includes at least one spring structure connected between at least one of the electrode plates and the ultrasonic vibrating equipment.

Optionally or preferably, the control system of chlorinated brine generator with descaling device further includes at least one ultrasonic coupling structure arranged on the ultrasonic vibrating equipment, and connected between the spring structure and the ultrasonic vibrating equipment.

Optionally or preferably, the descaling device further includes a support fixed to the cover, and the ultrasonic vibrating equipment is an ultrasonic vibrating rod fixed to the support and surrounded by the chlorinated brine generator.

Optionally or preferably, the electrode plates include at least one outer tubular mesh electrode and at least one inner tubular mesh electrode, and the at least one outer tubular mesh electrode, the at least one inner tubular mesh electrode, and the ultrasonic vibrating rod are concentric.

Optionally or preferably, the electrode plates include a plurality of outer planar mesh electrodes and a plurality of inner planar mesh electrodes.

(Second Aspect)

According to a second aspect of the present invention, there is provided a control system of chlorinated brine generator with descaling device, including an electrolysis cell and a controller unit. The electrolysis cell includes a cover, a chlorinated brine generator, a descaling device, and a vibrating tray. The cover includes an inlet and an outlet. A waterway is defined between the inlet and the outlet. The chlorinated brine generator is arranged in the waterway, and includes a plurality of electrode plates. The descaling device is arranged adjacent to the chlorinated brine generator and in the waterway, and includes at least one ultrasonic vibrating equipment. The ultrasonic vibrating equipment includes at least one vibrator. The vibrating tray surrounds the chlorinated brine generator and connected to the ultrasonic vibrating equipment. The controller unit includes an electrolysis-and-power controlling module, an ultrasonic generating module, and a main controlling module. The electrolysis-and-power controlling module is connected to the chlorinated brine generator, and configured to control the chlorinated brine generator. The ultrasonic generating module is connected to the descaling device, and configured to control the descaling device. The main controlling module is connected to the electrolysis-and-power controlling module and the ultrasonic generating module, and configured to control the electrolysis-and-power controlling module and the ultrasonic generating module, and save a descaling schedule.

Optionally or preferably, the vibrating tray has a plurality of holes which water in the waterway passes through.

Optionally or preferably, the control system of chlorinated brine generator with descaling device further includes at least one spring structure connected between at least one of the electrode plates and the vibrating tray.

Optionally or preferably, the control system of chlorinated brine generator with descaling device further includes at least one ultrasonic coupling structure arranged on the ultrasonic vibrating equipment, and connected between the vibrating tray and the ultrasonic vibrating equipment.

Optionally or preferably, the vibrating tray is further shaped to surround not only the chlorinated brine generator but also the descaling device.

(Third Aspect)

According to a third aspect of the present invention, there is provided a control system of chlorinated brine generator with descaling device, including an electrolysis cell and a controller unit. The electrolysis cell includes a cover, a chlorinated brine generator, a descaling device, and a vibrating tray. The cover includes an inlet and an outlet. A waterway is defined between the inlet and the outlet. The chlorinated brine generator is arranged in the waterway, and includes a plurality of electrode plates. The descaling device is arranged adjacent to the chlorinated brine generator and isolated from the waterway, and includes at least one ultrasonic vibrating equipment. The ultrasonic vibrating equipment includes at least one vibrator. The vibrating tray is arranged to surround the chlorinated brine generator and connected to the ultrasonic vibrating equipment (at backside, for example), and such that the descaling device is isolated from the waterway. The controller unit includes an electrolysis-and-power controlling module, an ultrasonic generating module, and a main controlling module. The electrolysis-and-power controlling module is connected to the chlorinated brine generator, and configured to control the chlorinated brine generator. The ultrasonic generating module is connected to the descaling device, and configured to control the descaling device. The main controlling module is connected to the electrolysis-and-power controlling module and the ultrasonic generating module, and configured to control the electrolysis-and-power controlling module and the ultrasonic generating module, and save a descaling schedule.

Optionally or preferably, the vibrating tray has a plurality of holes which water in the waterway passes through.

Optionally or preferably, the vibrating tray has a wavy structure.

Optionally or preferably, the control system of chlorinated brine generator with descaling device further includes at least one spring structure connected between at least one of the electrode plates and the vibrating tray.

Optionally or preferably, the control system of chlorinated brine generator with descaling device further includes at least one ultrasonic coupling structure arranged on the ultrasonic vibrating equipment, and connected between the vibrating tray and the ultrasonic vibrating equipment.

(Commonly Optional and Preferable Features)

Following optional and preferable features are applicable to the first aspect, the second aspect, and the third aspect of the present invention.

Optionally or preferably, the inlet is installed with an inlet valve, the outlet is installed with an outlet valve, and the controller unit is configured to open the inlet valve and the outlet valve during an electrolysis period, and close the inlet valve and the outlet valve during a descaling period.

Optionally or preferably, the ultrasonic vibrating equipment is waterproof.

Optionally or preferably, the control system of chlorinated brine generator with descaling device further includes an inlet coil surrounding the inlet, and/or an outlet coil surrounding the outlet, and/or a waterway coil surrounding the cover along the waterway.

Optionally or preferably, the controller unit includes a magnetic field current generating module connected to the coil(s) and the main controlling module.

Optionally or preferably, the control system of chlorinated brine generator with descaling device further includes at least one probe and/or at least one flow meter. The controller unit is configured to detect properties of water by the at least one probe and/or detect water flow by the at least one flow meter.

Optionally or preferably, the ultrasonic generating module is configured to control the ultrasonic vibrating equipment to generate variable frequency ultrasonic wave.

(Fourth Aspect)

According to a fourth aspect of the present invention, there is provided a control method of chlorinated brine generator with descaling device. The method is executed by a controller unit including an electrolysis-and-power controlling module, an ultrasonic generating module, and a main controlling module connected to the electrolysis-and-power controlling module and the ultrasonic generating module. The method includes following steps: Step S1 is using the main controlling module to perform a general process or a detection process including detecting properties of water by the at least one probe and/or detecting water flow by the at least one flow meter. Step S2 is using the electrolysis-and-power controlling module to control a chlorinated brine generator to start chlorination. Step S3 is using the main controlling module to determine whether the water reaches a preset chlorine concentration, and, when the water does not reach the preset chlorine concentration, continue chlorination; when the water reaches the preset chlorine concentration, stop chlorination, in preparation for descaling operation.

Optionally or preferably, the control method of chlorinated brine generator with descaling device further includes step S4, which is using the main controlling module to determine whether it reaches a descaling time, and, when it reaches the descaling time, stop chlorination.

Optionally or preferably, the control method of chlorinated brine generator with descaling device further includes step S5, which is using the main controlling module to determine whether it reaches a preset operating time of chlorination, and, when it reaches the preset operating time of chlorination, stop chlorination.

Optionally or preferably, the control method of chlorinated brine generator with descaling device further includes step S7, which is using the main controlling module to determine water flow, and, when the water flow does not stop, stop pump(s) and close valve(s).

Optionally or preferably, the control method of chlorinated brine generator with descaling device further includes step S8, which is using the ultrasonic generating module to control a descaling device to start descaling operation, when the chlorination stops and the water flow stops.

Optionally or preferably, the controller unit further includes a magnetic field current generating module connected to the main controlling module, and the method further includes step S6, which is using the magnetic field current generating module to control coil(s) to generate magnetic field(s).

Optionally or preferably, the control method of chlorinated brine generator with descaling device further includes at least one of following steps: Additional step SP1 is using the main controlling module to determine whether magnetic field operation is allowed to work simultaneously with the chlorinated brine generator during chlorination operation and, when it is allowed, perform step S6. Additional step SP2 is using the main controlling module to determine whether magnetic field operation is allowed to work simultaneously with the descaling device during descaling operation, and, when it is allowed, perform step S6. Additional step SP3 is using the main controlling module to determine whether magnetic field operation must work independently, and, when chlorination operation and descaling operation stop, perform step S6.

Optionally or preferably, the electrolysis-and-power controlling module is configured to output mixed type pulses.

Optionally or preferably, the mixed type pulses include a first pulse, a second pulse, and a third pulse appearing successively or randomly. The first pulse is formed by adding a basic pulse and a plurality of wide pulses. The second pulse is formed by adding the basic pulse and a plurality of medium pulses. The third pulse is formed by adding the basic pulse and a plurality of narrow pulses. Each narrow pulse period is shorter than each medium pulse period. Each medium pulse period is shorter than each wide pulse period. Each wide pulse period is shorter than the basic pulse period.

Optionally or preferably, polarity of odd-numbered pulses is different from polarity of even-numbered pulses. The first pulse and the third pulse belong to the odd-numbered pulses. The second pulse belongs to the even-numbered pulse.

Optionally or preferably, a voltage value between two pulses is equal to zero, or equal to that of the basic pulse, or multiple of that of the basic pulse.

Optionally or preferably, a plurality of narrow intensive pulses appear between the first pulse and the second pulse. A plurality of wide intensive pulses appear between the second pulse and the third pulse. The narrow intensive pulses and the wide intensive pulses appear in reverse order or in random order.

Optionally or preferably, a voltage value between two intensive pulses is equal to zero, or equal to that of the basic pulse.

Optionally or preferably, the narrow intensive pulses and the wide intensive pulses have negative polarities.

Other objects, advantages, and novel features of the invention will become more apparent from the following detailed description when taken in conjunction with the accompanying drawings.

### BRIEF DESCRIPTION OF THE DRAWINGS

FIG. 1A shows a schematic diagram of the control system of chlorinated brine generator with descaling device according to one embodiment of the present invention;

FIG. 1B shows a schematic diagram of the electrolysis cell according to another embodiment of the present invention, in particular provided with valves;

FIG. 1C shows a schematic diagram of the electrolysis cell according to another embodiment of the present invention, in particular provided with valves and a spring structure;

FIG. 2 shows a schematic diagram of the electrolysis cell according to another embodiment of the present invention, in particular provided with a vibrating tray;

FIG. 3 shows a schematic diagram of the electrolysis cell according to another embodiment of the present invention, in particular provided with a vibrating tray;

FIG. 4 shows a schematic diagram of the control system of chlorinated brine generator with descaling device according to another embodiment of the present invention;

FIG. 5 shows a schematic diagram of the electrolysis cell according to another embodiment of the present invention, in particular provided with a wavy structure and/or a spring structure;

FIG. 6A shows a schematic diagram of the electrolysis cell according to another embodiment of the present invention;

FIG. 6B shows a sectional view of the electrolysis cell in FIG. 6A;

FIG. 7A shows a schematic diagram of the electrolysis cell according to another embodiment of the present invention;

FIG. 7B shows a sectional view of the electrolysis cell in FIG. 7A;

FIG. 8 shows a schematic diagram of the control system of chlorinated brine generator with descaling device according to another embodiment of the present invention, in particular capable of generating magnetic field(s);

FIG. 9 shows a flowchart of the control method of chlorinated brine generator with descaling device according to one embodiment of the present invention;

FIGS. 10A and 10B show traditional waveforms outputted to electrodes of an electrolysis cell.

FIG. 11A shows an example of the mixed type pulses;

FIG. 11B shows another example of the mixed type pulses;

FIG. 11C shows another example of the mixed type pulses;

FIGS. 12A and 12B show other examples of the mixed type pulses; and

FIGS. 13A and 13B show other examples of the mixed type pulses.

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existent of another element described by a smaller ordinal number.

Moreover, in the present specification, the terms, such as “top”, “bottom”, “left”, “right”, “front”, “back”, or “middle”, as well as the terms, such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially means that the elements contact the other element, except otherwise specified. Such interpretation is applied to other cases similar to the case of “on”.

Moreover, in the present specification, the terms, such as “preferably” or “advantageously”, are used to describe an optional or additional element or feature, and in other words, the element or the feature is not an essential element, and may be ignored in some embodiments.

Moreover, each component may be realized as a single circuit or an integrated circuit in suitable ways, and may include one or more active elements, such as transistors or logic gates, or one or more passive elements, such as resistors, capacitors, or inductors, but not limited thereto. Each component may be connected to each other in suitable ways, for example, by using one or more traces to form series connection or parallel connection, especially to satisfy the requirements of input terminal and output terminal. Furthermore, each component may allow transmitting or receiving input signals or output signals in sequence or in parallel. The aforementioned configurations may be realized depending on practical applications.

Moreover, in the present specification, the terms, such as “system”, “apparatus”, “device”, “module”, or “unit”, refer to an electronic element, or a digital circuit, an analogous circuit, or other general circuit, composed of a plurality of electronic elements, and there is not essentially a level or a rank among the aforementioned terms, except otherwise specified.

Moreover, in the present specification, two elements may be electrically connected to each other directly or indirectly, except otherwise specified. In an indirect connection, one or more elements, such as resistors, capacitors, or inductors may exist between the two elements. The electrical connection is used to send one or more signals, such as DC or AC currents or voltages, depending on practical applications.

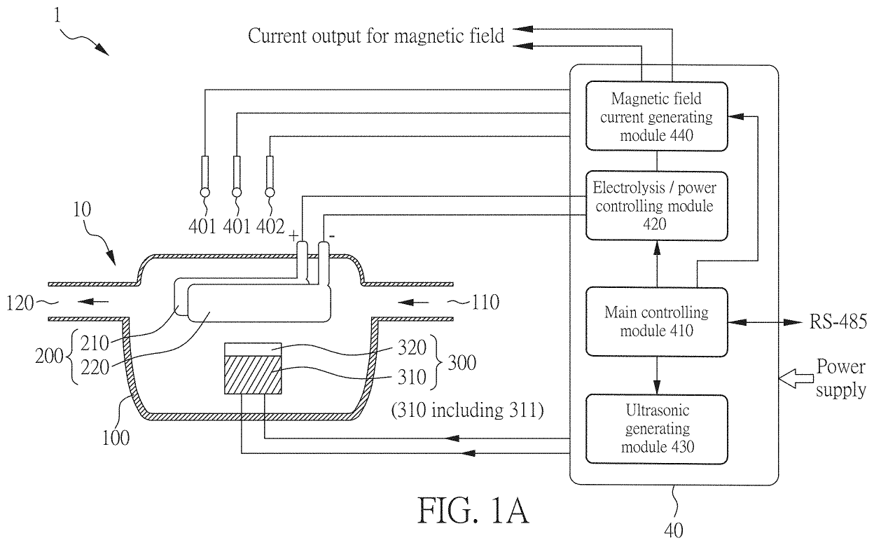

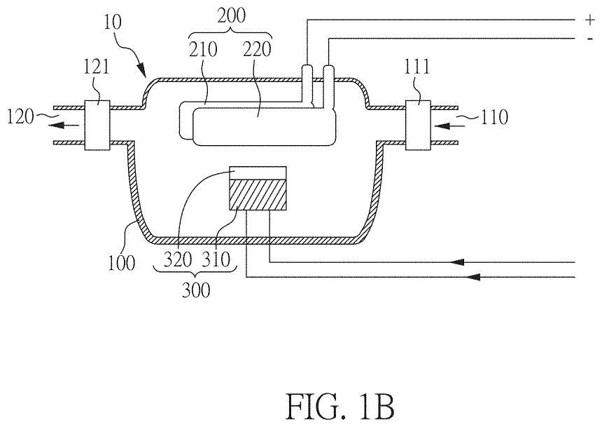

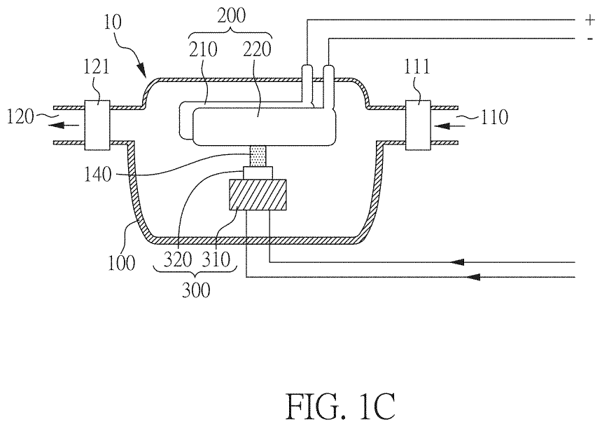

(FIG. 1A)

FIG. 1A shows a schematic diagram of the control system 1 of chlorinated brine generator with descaling device according to one embodiment of the present invention.

The control system 1 of chlorinated brine generator with descaling device may be used in a swimming pool or other water equipment.

As shown in FIG. 1A, the control system 1 of chlorinated brine generator with descaling device mainly includes an electrolysis cell 10 and a controller unit 40.

The electrolysis cell 10 includes a cover 100, a chlorinated brine generator 200, and a descaling device 300.

The cover 100 may include a top cover and a bottom cover. The cover 100 includes an inlet 110 and an outlet 120. A waterway is defined between the inlet 110 and the outlet 120. Water flows from the inlet 110 to the outlet 120. The water may come from the swimming pool or the other water equipment.

The chlorinated brine generator 200 is arranged in the waterway, and includes a plurality of electrode plates 210 and 220. The electrode plate 210 may have a positive polarity, and the electrode plate 220 may have a negative polarity. The electrode plates 210 and 220 may be made of metal(s) or other conductive material(s). In order to generate chlorine in a process of chlorination, the water is added with salt (such as NaCl) to become brine, and the brine is electrolyzed by the electrode plates 210 and 220 of the chlorinated brine generator 200. However, certain minerals (such as calcium ions) in the water will be attached to and deposited or accumulated on the electrode plates 210 and 220 (especially the negative electrode plate 220). The deposited or accumulated impurities will decrease the electrolysis efficiency.

The descaling device 300 is arranged adjacent to the chlorinated brine generator 200. FIG. 1A illustratively shows that the descaling device 300 is arranged below the chlorinated brine generator 200, but their relative location is not limited thereto. The descaling device 300 is arranged in the waterway in this embodiment, but it may be isolated from the waterway in other embodiments. The descaling device 300 includes at least one ultrasonic vibrating equipment 310. The ultrasonic vibrating equipment 310 includes at least one vibrator 311. In case of a plurality of vibrators 311, they may be arranged in a row or in an array according to optimization. The vibrator 311 of the ultrasonic vibrating equipment 310 of the descaling device 300 is used to generate ultrasonic waves, vibrating the water and transmitting the ultrasonic energy to the electrode plates 210 and 220, in order to remove the impurities deposited or accumulated on the electrode plates 210 and 220. This is called a descaling operation. The ultrasonic vibrating equipment 310 may have a metal coating to be waterproof or corrosion-proof. In some embodiments, at least one ultrasonic coupling structure 320 may be arranged on the ultrasonic vibrating equipment 310.

The controller unit 40 includes a main controlling module 410, an electrolysis-and-power controlling module 420, and an ultrasonic generating module 430. The modules 410, 420, and 430 may be realized as a single electronic device or separated electronic devices. The controller unit 40 may be arranged near or far from the electrolysis cell 10, as long as they are connected with each other.

The electrolysis-and-power controlling module 420 is connected to the chlorinated brine generator 200, and configured to control the chlorinated brine generator 200, in particular to control the electrode plates 210 and 220, and thus start or stop chlorination. Moreover, the electrolysis-and-power controlling module 420 may output a special waveform (formed by mixed type pulses) to the electrode plates 210 and 220 to mitigate undesired impurities deposited or accumulated on the electrode plates 210 and 220.

The ultrasonic generating module 430 is connected to the descaling device 300, and configured to control the descaling device 300, in particular to control the vibrator 311 of the ultrasonic vibrating equipment 310 to generate ultrasonic waves. In some embodiments, the ultrasonic generating module 430 may be configured to control the ultrasonic vibrating equipment 310 to generate variable frequency ultrasonic wave.

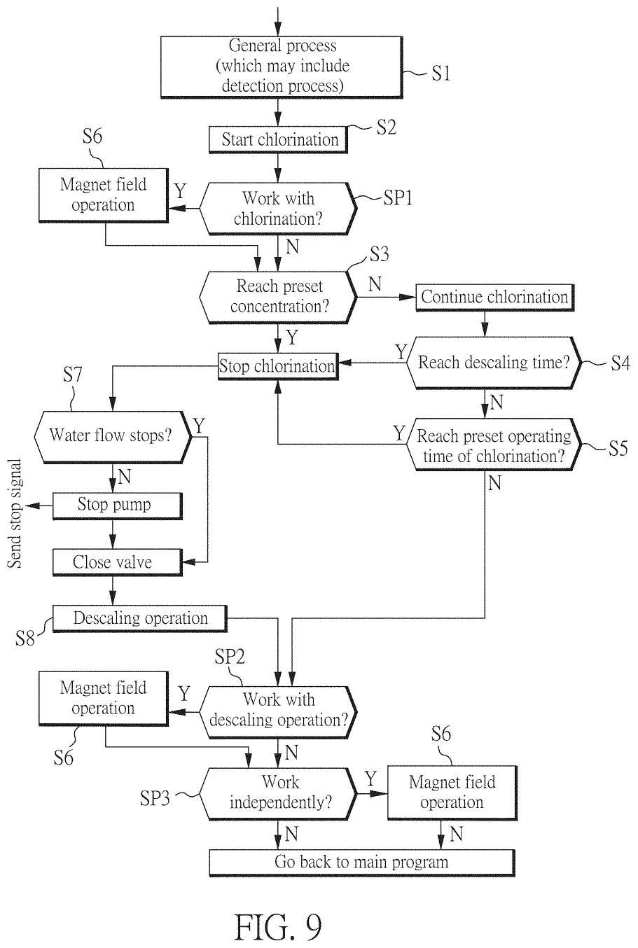

The main controlling module 410 is connected to the electrolysis-and-power controlling module 420 and the ultrasonic generating module 430, and configured to control the electrolysis-and-power controlling module 420 and the ultrasonic generating module 430, and save a descaling schedule. The descaling schedule saved in the main controlling module 410 may be used to execute a part of the control method of chlorinated brine generator with descaling device according to the present invention (as will be discussed in the following description relevant to FIG. 9).

In some embodiments, the control system 1 of chlorinated brine generator with descaling device may further include at least one probe 401 and/or at least one flow meter 402. The controller unit 40 is configured to detect properties of water by the at least one probe 401 and/or detect water flow by the at least one flow meter 402.

(Variable Frequency Ultrasonic Waves)

Variable frequency ultrasonic waves may be used to remove different types of impurities. The ultrasonic waves may be changed to a specific frequency (or band) that is effective in killing bacteria or eliminating algae. When the ultrasonic waves are emitted into water, their energy will induce strong shock waves and acoustic streaming, and at the same time, generate so-called “acoustic cavitation” in physics. A great number of cavitation bubbles collapse, release energy, and create a locally extreme physical environment with high temperature and high pressure. Water molecules entering the cavitation bubbles will undergo thermal decomposition, H₂O→H+OH, and thus produce hydroxyl radicals OH, with extremely high redox potential 2.4V. The hydroxyl radical is regarded as a disinfectant, which is a key of disinfection in advanced oxidation process (AOP).

(FIG. 1B)

FIG. 1B shows a schematic diagram of the electrolysis cell 10 according to another embodiment of the present invention, in particular provided with valves 111 and 121.

This embodiment of FIG. 1B is a variant of the embodiment of FIG. 1A, wherein the inlet 110 is installed with an inlet valve 111, and the outlet 120 is installed with an outlet valve 121.

The controller unit 40 is configured to open the inlet valve 111 and the outlet valve 121, so that the water flows during an electrolysis period. The controller unit 40 is configured to close the inlet valve 111 and the outlet valve 121, so that no external water enters the electrolysis cell 10 to disturb the descaling operation during a descaling period.

Other components, and their operations and effects in this embodiment are similar as those in the embodiment of FIG. 1A.

(FIG. 1C)

FIG. 1C shows a schematic diagram of the electrolysis cell 10 according to another embodiment of the present invention, in particular provided with valves 111 and 121 and a spring structure 140.

This embodiment of FIG. 1C is a variant of the embodiments of FIGS. 1A and 1B, wherein the electrolysis cell 10 includes at least one spring structure 140 connected between at least one of the electrode plates 210 and 220 and the ultrasonic coupling structure 320. In another embodiment, the ultrasonic coupling structure 320 may be omitted, and the spring structure 140 may be connected between at least one of the electrode plates 210 and 220 and the ultrasonic vibrating equipment 310. In this embodiment, vibration energy generated by the ultrasonic vibrating equipment 310 is transmitted to the electrode plates 210 and 220 through the ultrasonic coupling structure 320 and the spring structure 140. Such direct transmission of vibration energy helps removing the impurities deposited or accumulated on the electrode plates 210 and 220. The spring structure 140 may be a spring sheet, and it may have other shapes depending on practical applications.

Other components, and their operations and effects in this embodiment are similar as those in the embodiments of FIGS. 1A and 1B.

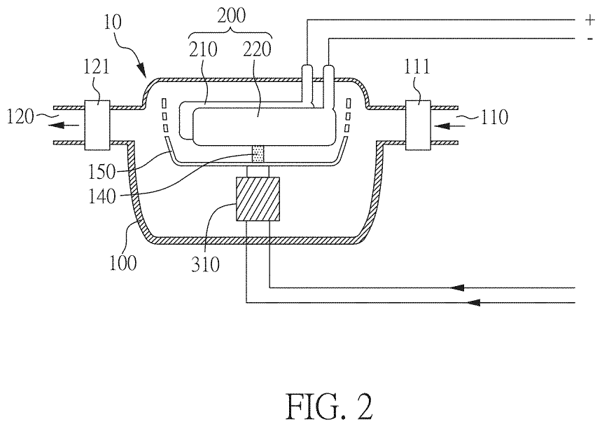

(FIG. 2)

FIG. 2 shows a schematic diagram of the electrolysis cell 10 according to another embodiment of the present invention, in particular provided with a vibrating tray 150.

This embodiment of FIG. 2 is a variant of the embodiments of FIGS. 1A and 1B, wherein the electrolysis cell 10 includes a vibrating tray 150 in addition to the cover 100, the chlorinated brine generator 200, and the descaling device 300. The vibrating tray 150 may be made of metal(s).

The vibrating tray 150 surrounds the chlorinated brine generator 200, and has a plurality of holes which water in the waterway passes through. In this embodiment of FIG. 2, the vibrating tray 150 is connected to the ultrasonic vibrating equipment 310 through the ultrasonic coupling structure 320, and thus vibrates with them. The vibrating tray 150 has an advantageous effect of aggregating or concentrating ultrasonic energy. In another embodiment, the ultrasonic coupling structure 320 may be omitted, and the vibrating tray 150 may be connected to the ultrasonic vibrating equipment 310 directly.

In some embodiments, the electrolysis cell 10 may further include at least one spring structure 140 connected between at least one of the electrode plates 210 and 220 and the vibrating tray 150, so that vibration energy generated by the ultrasonic vibrating equipment 310 is transmitted to the electrode plates 210 and 220. Such direct transmission of vibration energy helps removing the impurities deposited or accumulated on the electrode plates 210 and 220. The spring structure 140 may be a spring sheet, and it may have other shapes depending on practical applications.

Other components, and their operations and effects in this embodiment are similar as those in the embodiments of FIGS. 1A and 1B.

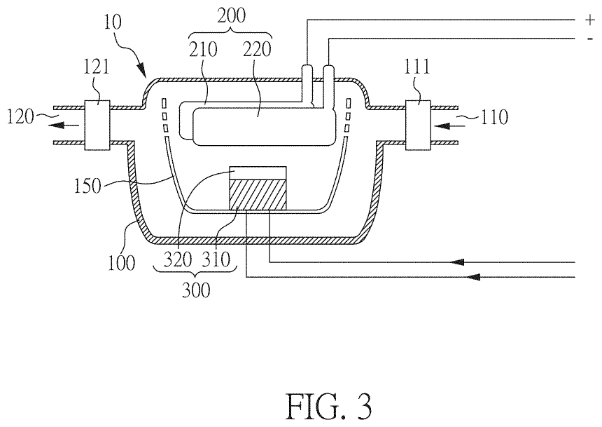

(FIG. 3)

FIG. 3 shows a schematic diagram of the electrolysis cell 10 according to another embodiment of the present invention, in particular provided with a vibrating tray 150.

This embodiment of FIG. 3 is a variant of the embodiments of FIGS. 1A and 1B, wherein the electrolysis cell 10 includes a vibrating tray 150 in addition to the cover 100, the chlorinated brine generator 200, and the descaling device 300.

The vibrating tray 150 is further shaped to surround not only the chlorinated brine generator 200 but also the descaling device 300, and has a plurality of holes which water in the waterway passes through. In this embodiment of FIG. 3, the vibrating tray 150 is connected to the ultrasonic vibrating equipment 310. FIG. 3 illustratively shows that the vibrating tray 150 is arranged below the ultrasonic vibrating equipment 310, but their relative location is not limited thereto.

Other components, and their operations and effects in this embodiment are similar as those in the embodiments of FIGS. 1A and 1B.

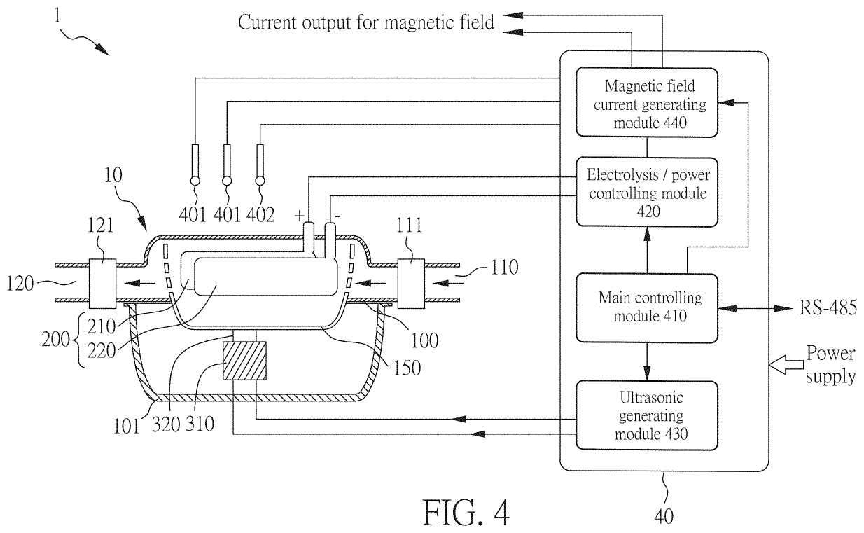

(FIG. 4)

FIG. 4 shows a schematic diagram of the control system 1 of chlorinated brine generator with descaling device according to another embodiment of the present invention.

It is noted that the electrolysis cell 10 in this embodiment of FIG. 4 has a different structure compared with that in the embodiment of FIG. 1A.

In this embodiment of FIG. 4, the descaling device 300 is arranged adjacent to the chlorinated brine generator 200, but isolated from the waterway.

In particular, the electrolysis cell 10 includes a vibrating tray 150 arranged to surround the chlorinated brine generator 200, and such that the descaling device 300 is isolated from the waterway. In this embodiment of FIG. 4, the vibrating tray 150 is connected to the ultrasonic vibrating equipment 310 through the ultrasonic coupling structure 320, and thus vibrates with them. In another embodiment, the ultrasonic coupling structure 320 may be omitted, and the vibrating tray 150 may be connected to the ultrasonic vibrating equipment 310 directly. Vibration energy generated by the ultrasonic vibrating equipment 310 is transmitted by the vibrating tray 150. The vibrating tray 150 has an advantageous effect of aggregating or concentrating ultrasonic energy.

In some embodiments, the vibrating tray 150 may have a plurality of holes which water in the waterway passes through.

In this embodiment of FIG. 4, the ultrasonic vibrating equipment 310 is not necessary to be waterproof since it is isolated from the waterway.

Other components, and their operations and effects in this embodiment are similar as those in the embodiment of FIG. 1A.

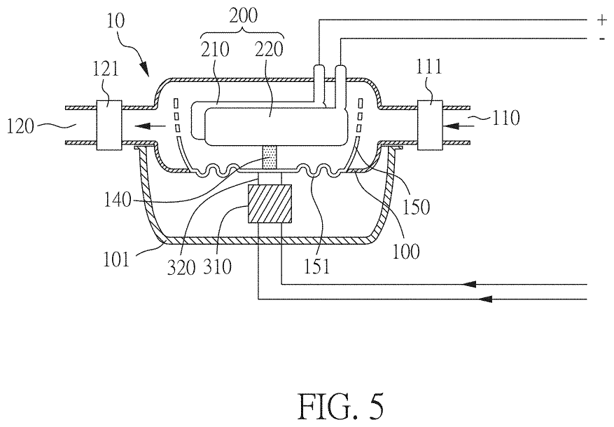

(FIG. 5)

FIG. 5 shows a schematic diagram of the electrolysis cell 10 according to another embodiment of the present invention, in particular provided with a wavy structure 151 and/or a spring structure 140

This embodiment of FIG. 5 is a variant of the embodiments of FIGS. 1A and 4, wherein the vibrating tray 150 further has a wavy structure 151 to enhance the vibration.

In some embodiments, the electrolysis cell 10 may further include at least one spring structure 140 connected between at least one of the electrode plates 210 and 220 and the vibrating tray 150, so that vibration energy generated by the ultrasonic vibrating equipment 310 is transmitted to the electrode plates 210 and 220. Such direct transmission of vibration energy helps removing the impurities deposited or accumulated on the electrode plates 210 and 220. The vibrating tray 150 has an advantageous effect of aggregating or concentrating ultrasonic energy. The spring structure 140 may be a spring sheet, and it may have other shapes depending on practical applications.

Other components, and their operations and effects in this embodiment are similar as those in the embodiments of FIGS. 1A and 4.

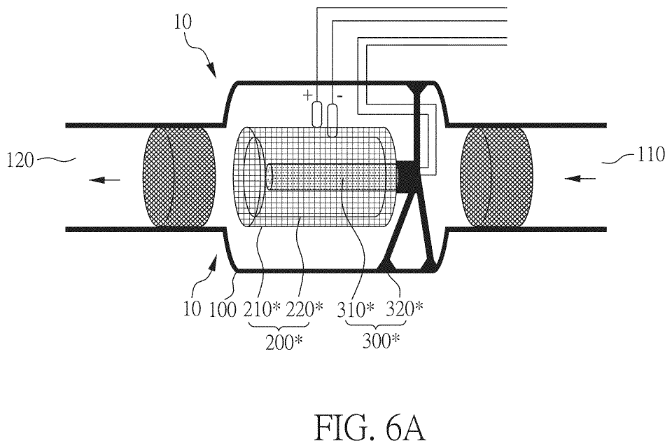

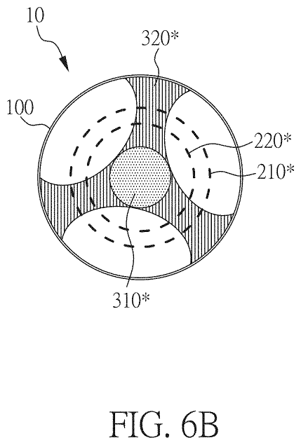

(FIGS. 6A and 6B)

FIG. 6A shows a schematic diagram of the electrolysis cell 10 according to another embodiment of the present invention, and FIG. 6B shows its sectional view.

The electrolysis cell 10 includes a cover 100, a chlorinated brine generator 200*, and a descaling device 300*.

The cover 100 may include a top cover and a bottom cover. The cover 100 includes an inlet 110 and an outlet 120. A waterway is defined between the inlet 110 and the outlet 120. Water flows from the inlet 110 to the outlet 120. In some embodiments, the inlet 110 may be installed with an inlet valve 111, and the outlet 120 may be installed with an outlet valve 121, as previously discussed in the embodiment of FIG. 1B.

The chlorinated brine generator 200 is arranged in the waterway, and includes at least one outer tubular mesh electrode 210* and at least one inner tubular mesh electrode 220* concentric to each other (to replace the electrode plates 210 and 220 in the embodiment of FIG. 1A). The outer tubular mesh electrode 210* may have a positive polarity, the inner tubular mesh electrode 220* may have a negative polarity, or vice versa. The electrodes 210* and 220* may be made of metal(s) or other conductive material(s). In order to generate chlorine in a process of chlorination, the water is added with salt (such as NaCl) to become brine, and the brine is electrolyzed by the electrodes 210* and 220* of the chlorinated brine generator 200*. However, certain minerals (such calcium ions) in the water will be attached to and deposited or accumulated on the electrodes 210* and 220* (especially the electrode having the negative polarity). The deposited or accumulated impurities will decrease the electrolysis efficiency.

Referring to the sectional view in FIG. 6B, the descaling device 300* is arranged adjacent to the chlorinated brine generator 200* and in the waterway as well. In particular, the descaling device 300* is surrounded by the chlorinated brine generator 200*. The descaling device 300* includes an ultrasonic vibrating equipment 310* and a support 320*. The ultrasonic vibrating equipment 310* is an ultrasonic vibrating rod 310* fixed to the support 320*. The support 320* is fixed to the cover 100. The ultrasonic vibrating rod 310* is substantially concentric to the outer tubular mesh electrode 210* and the inner tubular mesh electrode 220*, and substantially located in center of them. The ultrasonic vibrating rod 310* includes at least one vibrator (not shown). In case of a plurality of vibrators, they may be arranged in a row or in an array according to optimization. The vibrator of the ultrasonic vibrating rod 310* of the descaling device 300* is used to generate ultrasonic waves, vibrating the water and transmitting the ultrasonic energy to the electrodes 210* and 220*, in order to remove the impurities deposited or accumulated on the electrodes 210* and 220*. The ultrasonic vibrating rod 310* may have a metal coating to be waterproof or corrosion-proof.

It is noted that, in this embodiment, since the ultrasonic vibrating rod 310* is substantially concentric to the outer tubular mesh electrode 210* and the inner tubular mesh electrode 220*, and substantially located in center of them, the ultrasonic waves generated by the ultrasonic vibrating rod 310* effectively impact on the outer tubular mesh electrode 210* and the inner tubular mesh electrode 220*, without energy waste.

Moreover, since the impurities tend to be deposited or accumulated on the electrode having the negative polarity, and the inner tubular mesh electrode 220* is nearer the ultrasonic vibrating rod 310*, it is preferable to set the inner tubular mesh electrode 220* to have the negative polarity, so that the electrode having more impurities can match (or become) the electrode easier to be cleaned up.

Other components, and their operations and effects in this embodiment are similar as those in the embodiment of FIG. 1A.

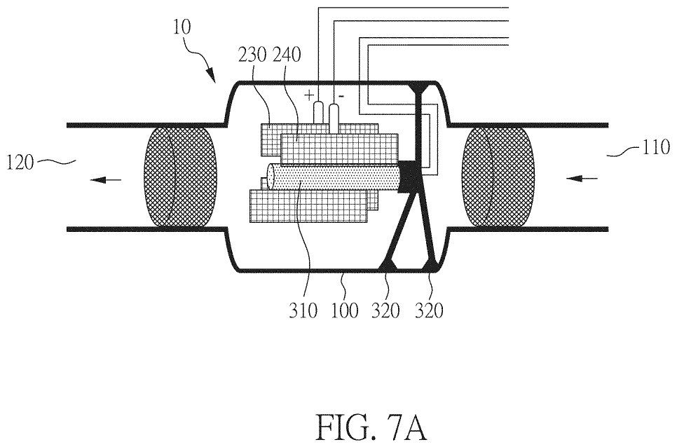

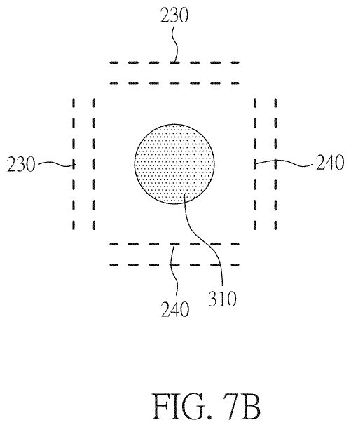

(FIGS. 7A and 7B)

FIG. 7A shows a schematic diagram of the electrolysis cell 10 according to another embodiment of the present invention, and FIG. 7B shows its sectional view.

This embodiment of FIGS. 7A and 7B is a variant of the embodiments of FIGS. 1A and 6A, wherein the chlorinated brine generator 200 includes a plurality of outer planar mesh electrodes 230 and a plurality of inner planar mesh electrodes 240, instead of the outer tubular mesh electrode 210* and the inner tubular mesh electrode 220*.

Referring to the sectional view in FIG. 7B, in this embodiment, since the outer planar mesh electrodes 230 and the inner planar mesh electrodes 240 still surround the ultrasonic vibrating rod 310*, the ultrasonic waves generated by the ultrasonic vibrating rod 310* effectively impact on the outer planar mesh electrodes 230 and the inner planar mesh electrodes 240, without energy waste.

Moreover, since the impurities tend to be deposited or accumulated on the electrode having the negative polarity, and the inner planar mesh electrodes 240 is nearer the ultrasonic vibrating rod 310*, it is preferable to set the inner planar mesh electrodes 240 to have the negative polarity, so that the electrode having more impurities can match (or become) the electrode easier to be cleaned up.

Other components, and their operations and effects in this embodiment are similar as those in the embodiments of FIGS. 1A and 6A.

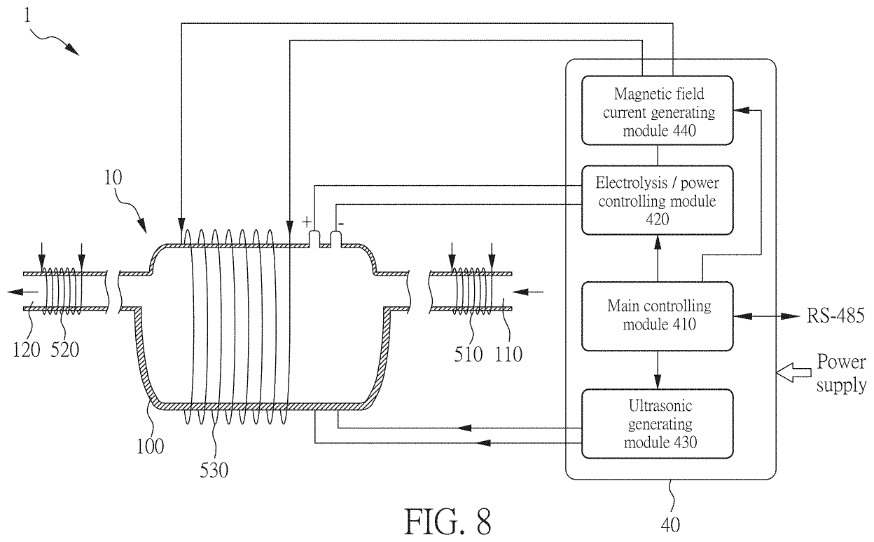

(FIG. 8)

FIG. 8 shows a schematic diagram of the control system 1 of chlorinated brine generator with descaling device according to another embodiment of the present invention, in particular capable of generating magnetic field(s).

In this embodiment, the control system 1 of chlorinated brine generator with descaling device further includes an inlet coil 510 surrounding the inlet 110, and/or an outlet coil 520 surrounding the outlet 120, and/or a waterway coil 530 surrounding the cover 100 along the waterway.

Moreover, the controller unit 40 further includes a magnetic field current generating module 440 connected to the coil(s) 510, 520, and/or 530, and the main controlling module 410. The magnetic field current generating module 440 is configured to control the coil(s) 510, 520, and/or 530 to generate magnetic field(s). The magnetic field can move the impurities, bacteria, or algae that have magnetic dipoles, or even destroy them. The magnetic field can also avoid scale formation in the waterway or help removing the scale.

Furthermore, the magnetic field can make impurities difficult to be deposited or accumulated on the electrode plates, or difficult to be deposited or accumulated over a very large area (on the electrode plates).

This embodiment of FIG. 8 may be combined with any of the aforementioned embodiments.

(FIG. 9)

FIG. 9 shows a flowchart of the control method of chlorinated brine generator with descaling device according to one embodiment of the present invention.

The method is applicable to the control system 1 of chlorinated brine generator with descaling device realized in any of the aforementioned embodiments. In particular, the method is executed by a controller unit 40 including an electrolysis-and-power controlling module 420, an ultrasonic generating module 430, and a main controlling module 410 connected to the electrolysis-and-power controlling module 420, and the ultrasonic generating module 430 (referring to FIG. 1A, for example).

The method of the present invention at least includes following steps:

Step S1 is using the main controlling module 410 to perform a general process or a detection process including detecting properties of water by the at least one probe and/or detecting water flow by the at least one flow meter.

Step S2 is using the electrolysis-and-power controlling module 420 to control a chlorinated brine generator 200 to start chlorination.

Step S3 is using the main controlling module 410 to determine whether the water reaches a preset chlorine concentration, and, when the water does not reach the preset chlorine concentration, continue chlorination; when the water reaches the preset chlorine concentration, stop chlorination, in preparation for descaling operation.

The method of the present invention may further include following optional or preferable steps:

Step S4 is using the main controlling module 410 to determine whether it reaches a descaling time, and, when it reaches the descaling time, stop chlorination. In particular, the module 410 may be configured to count elapsed time of an electrolysis period or a descaling period to determine whether it reaches the descaling time or descaling operation completes.

Step S5 is using the main controlling module 410 to determine whether it reaches a preset operating time of chlorination, and, when it reaches the preset operating time of chlorination, stop chlorination. In particular, the module 410 may be configured to count elapsed time of an electrolysis period to determine whether it reaches the preset operating time of chlorination. The preset operating time of chlorination is also regarded as a performing period of the chlorination. At the end of the preset operating time of chlorination, descaling operation is required.

Step S7 is using the main controlling module 410 to determine water flow, and, when the water flow does not stop, stop pump(s) and close valve(s). The pump(s) are typically installed in the swimming pool or other water equipment to pump the water, in particular, into the electrolysis cell 10. The main controlling module 410 may send a stop signal to stop the pump(s). The valve(s) are the inlet valve 111 and the outlet valve 121 as previously discussed.

Step S8 is using the ultrasonic generating module 430 to control a descaling device 300 to start descaling operation, when the chlorination stops and the water flow stops.

Moreover, as previously discussed in the embodiment of FIG. 8, the control system 1 of chlorinated brine generator with descaling device may further include at least one of coils 510, 520 or 530 surrounding the electrolysis cell 10, and the controller unit 40 may further include a magnetic field current generating module 440 connected to the main controlling module 410 and the coil(s).

Therefore, the method may further include at least one of following steps:

Step S6 is using the magnetic field current generating module 440 to control coil(s) 510, 520, 530 to generate magnetic field(s).

Additional step SP1 is using the main controlling module 410 to determine whether magnetic field operation is allowed to work simultaneously with the chlorinated brine generator 200 during chlorination operation and, when it is allowed, perform step S6.

Additional step SP2 is using the main controlling module 410 to determine whether magnetic field operation is allowed to work simultaneously with the descaling device 300 during descaling operation, and, when it is allowed, perform step S6.

Additional step SP3 is using the main controlling module 410 to determine whether magnetic field operation must work independently, and, when chlorination operation and descaling operation stop, perform step S6.

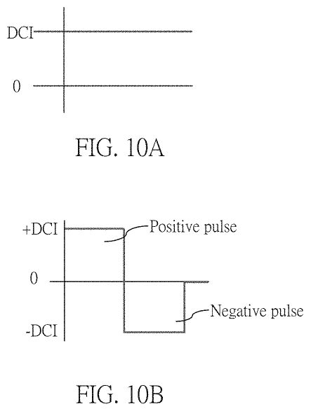

(FIGS. 10A and 10B)

FIGS. 10A and 10B show traditional waveforms outputted to electrodes of an electrolysis cell, wherein FIG. 10A shows a simple DC current, and FIG. 10B shows a waveform formed by a positive pulse and a negative pulse.

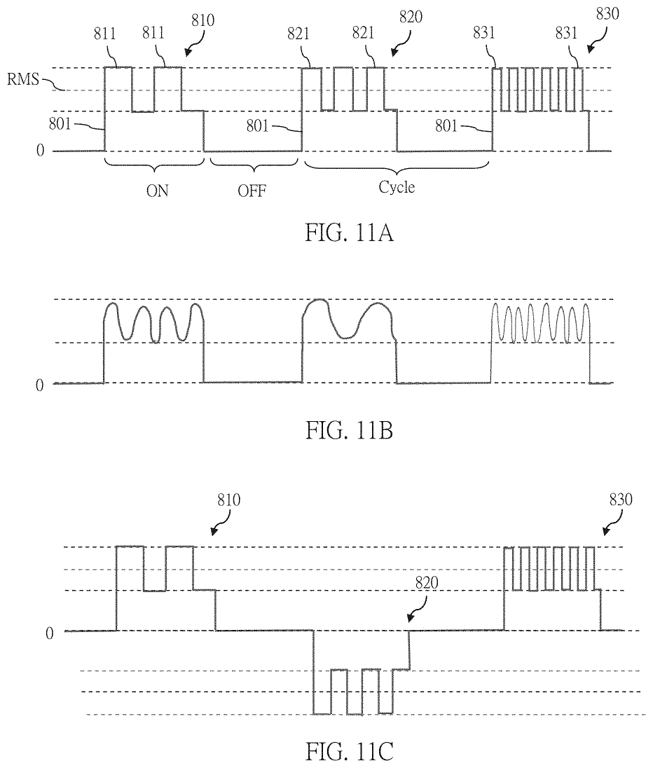

(FIG. 11A)

As previously discussed in the embodiment of FIG. 1A, the electrolysis-and-power controlling module 420 may output a special waveform (formed by mixed type pulses) to the electrode plates 210 and 220 to mitigate undesired impurities deposited or accumulated on the electrode plates 210 and 220. The waveform is designed to select desired chemical elements to join the chlorination (i.e. electrolysis), and deselect undesired chemical elements. The waveform may be formed by pulses (generally, waves) with different frequencies and different amplitudes.

To discuss about descaling principle of mixed type pulses, impurities (or electrolytes) in the water can form multilayers on the electrode plates 210 and 220. Different frequencies of currents may be effective in removing different layers formed of different impurities (typically having different thicknesses). For example, sodium chloride is usually deposited to be a first layer on the electrode plates 210 and 220 because it has the highest concentration, and other impurities are deposited to be a second layer on the first layer. A power signal of a specific frequency may be used to remove an unwanted impurity layer.

FIG. 11A shows an example of the mixed type pulses.

As shown in FIG. 11A, the mixed type pulses include a first pulse 810, a second pulse 820, and a third pulse 830. They may appear successively or randomly.

The first pulse 810 is formed by adding a basic pulse 801 and a plurality of wide pulses 811. The second pulse 820 is formed by adding the basic pulse 801 and a plurality of medium pulses 821. The third pulse 830 is formed by adding the basic pulse 801 and a plurality of narrow pulses 831.

Each narrow pulse 831 period is shorter than each medium pulse 821 period, each medium pulse 821 period is shorter than each wide pulse 811 period, and each wide pulse 811 period is shorter than the basic pulse 801 period.

(FIG. 11B)

FIG. 11B shows another example of the mixed type pulses.

As shown in FIG. 11B, the pulses are not necessary to be perfect square pulses, in particular, they are not necessary to have sharp rising edges or sharp falling edges.

(FIG. 11C)

FIG. 11C shows another example of the mixed type pulses.

As shown in FIG. 11C, polarity of odd-numbered pulses is different from polarity of even-numbered pulses. As illustratively shown in FIG. 11C, the first pulse 810 and the third pulse 830 belong to the odd-numbered pulses, and the second pulse 820 belongs to the even-numbered pulse.

(FIGS. 12A and 12B)

FIGS. 12A and 12B show other examples of the mixed type pulses.

Comparing FIGS. 1A, 12A, and 12B, a voltage value between two pulses (between pulses 810 and 820, or between pulses 820 and 830) is equal to zero, as shown in FIG. 11A, or equal to that of the basic pulse, as shown in FIG. 12A, or multiple of that of the basic pulse, as shown in FIG. 12B.

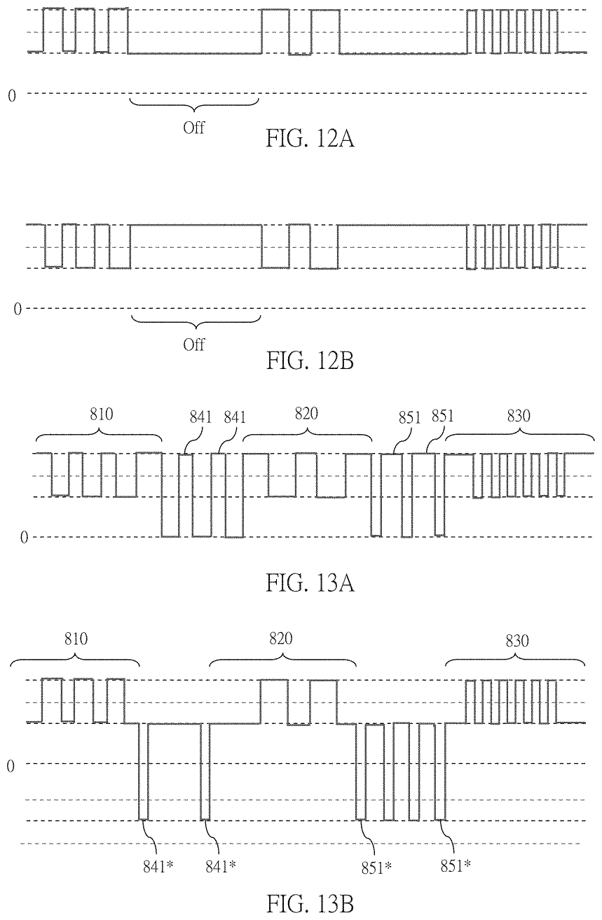

(FIGS. 13A and 13B)

FIGS. 13A and 13B show other examples of the mixed type pulses.

As shown in FIG. 13A, a plurality of narrow intensive pulses 841 appear between the first pulse 810 and the second pulse 820, a plurality of wide intensive pulses 851 appear between the second pulse 820 and the third pulse 830. The narrow intensive pulses 841 and the wide intensive pulses 851 may appear in reverse order or in random order.

Moreover, a voltage value between two intensive pulses 841 or 851 is equal to zero, or equal to that of the basic pulse.

As shown in FIG. 13B, the narrow intensive pulses 841 and the wide intensive pulses 851 have negative polarities.

Indeed, the mixed type pulses are not limited to the aforementioned embodiments of FIGS. 1A to 13B, the mixed type pulses in the aforementioned embodiments of FIGS. 11A to 13B may be modified and varied with each other to form other kinds of mixed type pulses.

Although the present invention has been explained in relation to its preferred embodiment, it is to be understood that many other possible modifications and variations can be made without departing from the spirit and scope of the invention as hereinafter claimed.

What is claimed is:

1. A control system of chlorinated brine generator with descaling device, comprising:
an electrolysis cell including:
a cover including an inlet and an outlet, wherein a waterway is defined between the inlet and the outlet;
a chlorinated brine generator arranged in the waterway, and including a plurality of electrode plates; and
a descaling device arranged adjacent to the chlorinated brine generator and in the waterway, and including at least one ultrasonic vibrating equipment; the ultrasonic vibrating equipment including at least one vibrator; and
a controller unit including:
an electrolysis-and-power controlling module connected to the chlorinated brine generator, and configured to control the chlorinated brine generator;
an ultrasonic generating module connected to the descaling device, and configured to control the descaling device; and
a main controlling module connected to the electrolysis-and-power controlling module and the ultrasonic generating module, and configured to control the electrolysis-and-power controlling module and the ultrasonic generating module, and save a descaling schedule.

2. The control system of chlorinated brine generator with descaling device of claim 1, wherein the inlet is installed with an inlet valve, the outlet is installed with an outlet valve, and the controller unit is configured to open the inlet valve and the outlet valve during an electrolysis period, and close the inlet valve and the outlet valve during a descaling period.

3. The control system of chlorinated brine generator with descaling device of claim 1, wherein the ultrasonic vibrating equipment is waterproof.

4. The control system of chlorinated brine generator with descaling device of claim 1, further comprising at least one spring structure connected between at least one of the electrode plates and the ultrasonic vibrating equipment, and/or at least one ultrasonic coupling structure connected between the spring structure and the ultrasonic vibrating equipment.

5. The control system of chlorinated brine generator with descaling device of claim 1, wherein the descaling device further includes a support fixed to the cover, and the ultrasonic vibrating equipment is an ultrasonic vibrating rod fixed to the support and surrounded by the chlorinated brine generator.

6. The control system of chlorinated brine generator with descaling device of claim 5, wherein the electrode plates include at least one outer tubular mesh electrode and at least one inner tubular mesh electrode, and the at least one outer tubular mesh electrode, the at least one inner tubular mesh electrode, and the ultrasonic vibrating rod are concentric.

7. The control system of chlorinated brine generator with descaling device of claim 5, wherein the electrode plates include a plurality of outer planar mesh electrodes and a plurality of inner planar mesh electrodes.

8. The control system of chlorinated brine generator with descaling device of claim 1, further comprising an inlet coil surrounding the inlet, and/or an outlet coil surrounding the outlet, and/or a waterway coil surrounding the cover along the waterway.

9. The control system of chlorinated brine generator with descaling device of claim 8, wherein the controller unit includes a magnetic field current generating module connected to the coil(s) and the main controlling module.

10. The control system of chlorinated brine generator with descaling device of claim 1, further comprising at least one probe and/or at least one flow meter; the controller unit being configured to detect properties of water by the at least one probe and/or detect water flow by the at least one flow meter.

11. The control system of chlorinated brine generator with descaling device of claim 1, wherein the ultrasonic generating module is configured to control the ultrasonic vibrating equipment to generate variable frequency ultrasonic wave.

12. A control system of chlorinated brine generator with descaling device, comprising:
an electrolysis cell including:
a cover including an inlet and an outlet, wherein a waterway is defined between the inlet and the outlet;
a chlorinated brine generator arranged in the waterway, and including a plurality of electrode plates;
a descaling device arranged adjacent to the chlorinated brine generator and in the waterway, and including at least one ultrasonic vibrating equipment; the ultrasonic vibrating equipment including at least one vibrator; and
a vibrating tray surrounding the chlorinated brine generator and connected to the ultrasonic vibrating equipment; and
a controller unit including:
an electrolysis-and-power controlling module connected to the chlorinated brine generator, and configured to control the chlorinated brine generator;
an ultrasonic generating module connected to the descaling device, and configured to control the descaling device; and
a main controlling module connected to the electrolysis-and-power controlling module and the ultrasonic generating module, and configured to control the electrolysis-and-power controlling module and the ultrasonic generating module, and save a descaling schedule.

13. The control system of chlorinated brine generator with descaling device of claim 12, wherein the inlet is installed with an inlet valve, the outlet is installed with an outlet valve, and the controller unit is configured to open the inlet valve and the outlet valve during an electrolysis period, and close the inlet valve and the outlet valve during a descaling period.

14. The control system of chlorinated brine generator with descaling device of claim 12, wherein the vibrating tray has a plurality of holes which water in the waterway passes through.

15. The control system of chlorinated brine generator with descaling device of claim 12, wherein the ultrasonic vibrating equipment is waterproof.

16. The control system of chlorinated brine generator with descaling device of claim 12, further comprising at least one spring structure connected between at least one of the electrode plates and the vibrating tray, and/or at least one ultrasonic coupling structure connected between the ultrasonic vibrating equipment and the vibrating tray.

17. The control system of chlorinated brine generator with descaling device of claim 12, wherein the vibrating tray is further shaped to surround not only the chlorinated brine generator but also the descaling device.

18. The control system of chlorinated brine generator with descaling device of claim 12, further comprising an inlet coil surrounding the inlet, and/or an outlet coil surrounding the outlet, and/or a waterway coil surrounding the cover along the waterway.

19. The control system of chlorinated brine generator with descaling device of claim 18, wherein the controller unit includes a magnetic field current generating module connected to the coil(s) and the main controlling module.

20. The control system of chlorinated brine generator with descaling device of claim 12, wherein the ultrasonic generating module is configured to control the ultrasonic vibrating equipment to generate variable frequency ultrasonic wave.

21. A control system of chlorinated brine generator with descaling device, comprising:
an electrolysis cell including:
a cover including an inlet and an outlet, wherein a waterway is defined between the inlet and the outlet;
a chlorinated brine generator arranged in the waterway, and including a plurality of electrode plates;
a descaling device arranged adjacent to the chlorinated brine generator and isolated from the waterway, and including at least one ultrasonic vibrating equipment; the ultrasonic vibrating equipment including at least one vibrator; and
a vibrating tray arranged to surround the chlorinated brine generator and connected to the ultrasonic vibrating equipment, and such that the descaling device is isolated from the waterway; and
a controller unit including:
an electrolysis-and-power controlling module connected to the chlorinated brine generator, and configured to control the chlorinated brine generator;
an ultrasonic generating module connected to the descaling device, and configured to control the descaling device; and
a main controlling module connected to the electrolysis-and-power controlling module and the ultrasonic generating module, and configured to control the electrolysis-and-power controlling module and the ultrasonic generating module, and save a descaling schedule.

22. The control system of chlorinated brine generator with descaling device of claim 21, wherein the inlet is installed with an inlet valve, the outlet is installed with an outlet valve, and the controller unit is configured to open the inlet valve and the outlet valve during an electrolysis period, and close the inlet valve and the outlet valve during a descaling period.

23. The control system of chlorinated brine generator with descaling device of claim 21, wherein the vibrating tray has a plurality of holes which water in the waterway passes through.

24. The control system of chlorinated brine generator with descaling device of claim 21, wherein the vibrating tray has a wavy structure.

25. The control system of chlorinated brine generator with descaling device of claim 21, further comprising at least one spring structure connected between at least one of the electrode plates and the vibrating tray, and/or at least one ultrasonic coupling structure connected between the ultrasonic vibrating equipment and the vibrating tray.

26. The control system of chlorinated brine generator with descaling device of claim 21, further comprising an inlet coil surrounding the inlet, and/or an outlet coil surrounding the outlet, and/or a waterway coil surrounding the cover along the waterway.

27. The control system of chlorinated brine generator with descaling device of claim 26, wherein the controller unit includes a magnetic field current generating module connected to the coil(s) and the main controlling module.

28. The control system of chlorinated brine generator with descaling device of claim 21, wherein the ultrasonic generating module is configured to control the ultrasonic vibrating equipment to generate variable frequency ultrasonic wave.

29. A control method of chlorinated brine generator with descaling device,
the method being executed by a controller unit including an electrolysis-and-power controlling module, an ultrasonic generating module, and a main controlling module connected to the electrolysis-and-power controlling module and the ultrasonic generating module;
the method comprising following steps:
step S1: using the main controlling module to perform a general process or a detection process including detecting properties of water by the at least one probe and/or detecting water flow by the at least one flow meter;
step S2: using the electrolysis-and-power controlling module to control a chlorinated brine generator to start chlorination; and
step S3: using the main controlling module to determine whether the water reaches a preset chlorine concentration, and, when the water does not reach the preset chlorine concentration, continue chlorination; when the water reaches the preset chlorine concentration, stop chlorination, in preparation for descaling operation.

30. The control method of chlorinated brine generator with descaling device of claim 29, further comprising step S4: using the main controlling module to determine whether it reaches a descaling time, and, when it reaches the descaling time, stop chlorination.

31. The control method of chlorinated brine generator with descaling device of claim 30, further comprising step S5: using the main controlling module to determine whether it reaches a preset operating time of chlorination, and, when it reaches the preset operating time of chlorination, stop chlorination.

32. The control method of chlorinated brine generator with descaling device of claim 29, further comprising step S7: using the main controlling module to determine water flow, and, when the water flow does not stop, stop pump(s) and close valve(s).

33. The control method of chlorinated brine generator with descaling device of claim 29, further comprising step S8: using the ultrasonic generating module to control a descaling device to start descaling operation, when the chlorination stops and the water flow stops.

34. The control method of chlorinated brine generator with descaling device of claim 29, wherein the controller unit further includes a magnetic field current generating module connected to the main controlling module, and the method further comprises step S6: using the magnetic field current generating module to control coil(s) to generate magnetic field(s).

35. The control method of chlorinated brine generator with descaling device of claim 34, further comprising following steps:
additional step SP1: using the main controlling module to determine whether magnetic field operation is allowed to work simultaneously with the chlorinated brine generator during chlorination operation and, when it is allowed, perform step S6; and/or
additional step SP2: using the main controlling module to determine whether magnetic field operation is allowed to work simultaneously with the descaling device during descaling operation, and, when it is allowed, perform step S6; and/or
additional step SP3: using the main controlling module to determine whether magnetic field operation must work independently, and, when chlorination operation and descaling operation stop, perform step S6.

36. The control system of chlorinated brine generator with descaling device of claim 29, wherein the electrolysis-and-power controlling module is configured to output mixed type pulses.

37. The control system of chlorinated brine generator with descaling device of claim 36, wherein the mixed type pulses include a first pulse, a second pulse, and a third pulse appearing successively or randomly, the first pulse is formed by adding a basic pulse and a plurality of wide pulses, the second pulse is formed by adding the basic pulse and a plurality of medium pulses, the third pulse is formed by adding the basic pulse and a plurality of narrow pulses, and each narrow pulse period is shorter than each medium pulse period, each medium pulse period is shorter than each wide pulse period, and each wide pulse period is shorter than the basic pulse period.

38. The control system of chlorinated brine generator with descaling device of claim 37, wherein polarity of odd-numbered pulses is different from polarity of even-numbered pulses, the first pulse and the third pulse belong to the odd-numbered pulses, and the second pulse belongs to the even-numbered pulse.

39. The control system of chlorinated brine generator with descaling device of claim 37, wherein a voltage value between two pulses is equal to zero, or equal to that of the basic pulse, or multiple of that of the basic pulse.

40. The control system of chlorinated brine generator with descaling device of claim 37, wherein a plurality of narrow intensive pulses appear between the first pulse and the second pulse, a plurality of wide intensive pulses appear between the second pulse and the third pulse, and the narrow intensive pulses and the wide intensive pulses appear in reverse order or in random order.

41. The control system of chlorinated brine generator with descaling device of claim 40, wherein a voltage value between two intensive pulses is equal to zero, or equal to that of the basic pulse.

42. The control system of chlorinated brine generator with descaling device of claim 41, wherein the narrow intensive pulses and the wide intensive pulses have negative polarities.
